(19) United States
(12) Patent Application Publication
(10) Pub. No.: US 2025/0083601 A1
(43) Pub. Date: Mar. 13, 2025

(54) MULTI-SENSOR, MULTI-AXIS MIRROR POSITIONING SYSTEM

(71) Applicant: Gentex Corporation, Zeeland, MI (US)

(72) Inventors: Ryan Barrido Balili, Holland, MI (US); Robert R. Turnbull, Holland, MI (US); Daniel J. Weber, Kentwood, MI (US)

(21) Appl. No.: 18/826,336

(22) Filed: Sep. 6, 2024

Related U.S. Application Data
(60) Provisional application No. 63/537,634, filed on Sep. 11, 2023.

(51) Int. Cl. B60R 1/12; B60R 1/04; G01B 7/00; G01B 7/30

(52) U.S. Cl. CPC B60R 1/12; B60R 1/04; G01B 7/003; G01B 7/30; B60R 2001/1223

(57) ABSTRACT

A rearview assembly includes a mount, having a ball joint portion, and a main unit including a housing with a socket that receives the ball joint portion such that the main unit is articulable on the mount by rotation about three perpendicular axes. First and second magnets are positioned within the housing and are spaced apart to define a rotationally asymmetric combined magnetic field. First and second sensors are positioned within the housing are spaced apart so as to be collectively operably associated with the combined magnetic field, with articulation of the main unit on the mount causing movement of the first and second sensors with respect to the first and second magnets. A processor determines a rotational position of the main unit in relation to the mount about the three axes based on a combination of the magnetic field information from the first sensor and second sensors.

### CROSS-REFERENCE TO RELATED APPLICATION

This application claims priority to and the benefit under 35 U.S.C. § 119 (e) of U.S. Provisional Application No. 63/537,634, filed on Sep. 11, 2023, entitled “MULTI-SENSOR, MULTI-AXIS MIRROR POSITIONING SYSTEM,” the disclosure of which is hereby incorporated herein by reference in its entirety.

### BACKGROUND

The present disclosure relates generally to a vehicle rearview assembly and more particularly, relates to an assembly with a sensor configured to determine the axis orientation information of a main unit of the assembly relative to a mount.

Various features have been introduced to different types of vehicular rearview assemblies that can be augmented by the capability to determine the location and orientation, or pose, of a body of the rearview with respect to a base and/or the vehicle interior. Previous systems have been deficient, at least, with respect to the ability to measure movement, in three axes, of the rearview body about a mount, particularly with respect to measuring the roll of the rearview body. Additionally, existing systems may lack the ability to track the movement of the rearview body about a base, when connected by an arm with multiple joints.

### SUMMARY

According to one aspect of the present disclosure, a rearview assembly includes a mount having an arm with a first end and a second end, wherein the first end includes a first ball joint portion and a main unit including a front face secured to a housing. The housing has a first socket disposed on an interior thereof adjacent an aperture disposed opposite the front face. The socket rotatably receives the first ball joint portion such that the first ball joint portion of the mount is at least partially disposed within the housing and such that the main unit is articulable on the mount by rotation about three perpendicular axes. The assembly further includes first and second magnets positioned within one of the housing or the first ball joint portion and mutually spaced apart to define a rotationally asymmetric combined magnetic field within the housing and first and second sensors at least partially positioned within the other of the housing or the first ball joint portion and being mutually spaced apart so as to be collectively operably associated with the combined magnetic field. Articulation of the main unit on the mount causing movement of the first and second sensors with respect to the first and second magnets. A processor is in communication with the first and second sensors to receive magnetic field information related to the combined magnetic field from the first sensor and second sensor and to determine a rotational position of the main unit in relation to the mount about each of the three perpendicular axes based on a combination of the magnetic field information from the first sensor and the second sensor.

According to another aspect of the present disclosure, a rearview assembly includes a mount having an arm with a first end and a second end, wherein the first end includes a first ball joint portion and a main unit including a front face secured to a housing. The housing has a first socket disposed on an interior thereof adjacent an aperture disposed opposite the front face, and the socket rotatably receives the first ball joint portion such that the first ball joint portion of the mount is at least partially disposed within the housing and such that the main unit is articulable on the mount by rotation about three perpendicular axes. The assembly further includes first and second magnets positioned within the first ball joint portion and mutually spaced apart to define a first rotationally asymmetric combined magnetic field within the housing and first and second sensors positioned within the housing and being mutually spaced apart so as to be collectively operably associated with the first combined magnetic field. Articulation of the main unit on the mount cause movement of the first and second sensors with respect to the first and second magnets. A processor is in communication with the first and second sensors to receive magnetic field information related to the first combined magnetic field from the first sensor and second sensor and to determine a rotational position of the main unit in relation to the mount about each of the three perpendicular axes based on a combination of the magnetic field information from the first sensor and the second sensor.

According to another aspect of the present disclosure, a rearview positioning system includes a mount having an arm with a first end and a second end, the first end including a first ball joint portion, and the mount being coupleable within a vehicle interior. The system further includes a main unit including a front face secured to a housing. The housing has a first socket disposed on an interior thereof adjacent an aperture disposed opposite the front face. The socket rotatably receives the first ball joint portion such that the first ball joint portion of the mount is at least partially disposed within the housing and such that the main unit is articulable on the mount by rotation about three perpendicular axes. First and second magnets are mutually spaced apart to define a rotationally asymmetric combined magnetic field, and first and second sensors are mutually spaced apart so as to be collectively operably associated with the combined magnetic field. Articulation of the main unit on the mount causes movement of the first and second sensors with respect to the first and second magnets. A processor is in communication with the first and second sensors, one of the first and second sensors or the first and second magnets are mounted in a fixed position relative to the vehicle interior, and the other of the first and second sensors or the first and second magnets are mounted within the main unit. The processor is configured to receive magnetic field information related to the combined magnetic field from the first sensor and second sensor and to determine a position of the main unit in relation to the mount about each of the three perpendicular axes based on a combination of the magnetic field information from the first sensor and the second sensor.

These and other features, advantages, and objects of the present device will be further understood and appreciated by those skilled in the art upon studying the following specification, claims, and appended drawings.

### BRIEF DESCRIPTION OF THE DRAWINGS

The present invention will become more fully understood from the detailed description and the accompanying drawings, wherein:

FIG. 1 is a perspective view of a rearview assembly according to an aspect of the disclosure with a main unit thereof in a first position relative to a mount;

FIG. 2 is a perspective view of the rearview assembly with the main unit in a second position relative to the mount;

FIG. 3 is a perspective view of the rearview assembly with the main unit in a third position relative to the mount;

FIG. 4 is a front perspective exploded view of the rearview assembly;

FIG. 5 is a rear perspective exploded view of the rearview assembly;

FIG. 6 is a front plan view of internal components of the rearview assembly in with the main unit thereof in the first position relative to the mount;

FIG. 7 is a front plan view of the internal components of the rearview assembly in with the main unit thereof in the second position relative to the mount;

FIG. 8 is a front plan view of the internal components of the rearview assembly in with the main unit thereof in the second position relative to the mount;

FIGS. 9A and 9B are top and front schematic views of a variation of a magnet and sensor arrangement useable in connection with the disclosed rearview assembly;

FIGS. 10A and 10B are top and front schematic views of a further variation of a magnet and sensor arrangement useable in connection with the disclosed rearview assembly;

FIGS. 11A and 11B are top and front schematic views of a further variation of a magnet and sensor arrangement useable in connection with the disclosed rearview assembly;

FIGS. 12A and 12B are top and front schematic views of a further variation of a magnet and sensor arrangement useable in connection with the disclosed rearview assembly;

FIGS. 13A and 13B are top and front schematic views of a further variation of a magnet and sensor arrangement useable in connection with the disclosed rearview assembly;

FIGS. 14A and 14B are top and front schematic views of a still further variation of a magnet and sensor arrangement useable in connection with the disclosed rearview assembly;

FIGS. 15A and 15B are top and front schematic views of a still further variation of a magnet and sensor arrangement useable in connection with the disclosed rearview assembly;

FIG. 16 is a front perspective view of a rearview assembly according to a further aspect of the disclosure; and

FIG. 17 is a rear perspective view of the rearview assembly of FIG. 16; and

FIG. 18 is a front perspective view of a rearview assembly according to a further aspect of the disclosure.

### DETAILED DESCRIPTION OF EMBODIMENTS

The present illustrated embodiments reside primarily in combinations of method steps and apparatus components related to an imaging and display system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

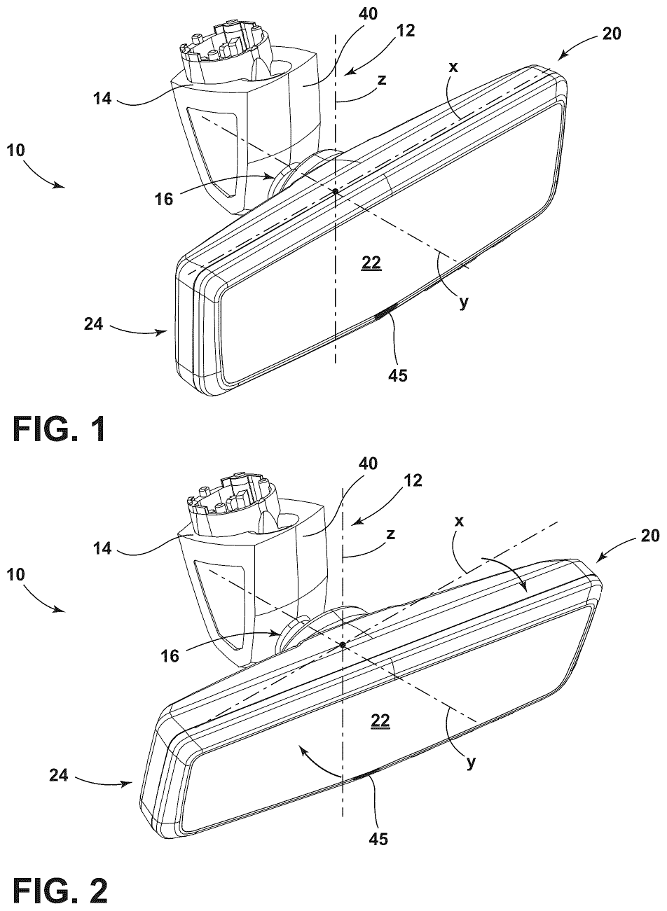

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Ordinal modifiers (i.e., “first”, “second”, etc.) may be used to distinguish between various structures of the disclosed transportation rack in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including”, “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially”, are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIGS. 1-8, reference numeral 10 generally designates a rearview assembly. The rearview assembly 10 includes a mount 12 having a first end 14 and a second end 16 having a ball joint portion 18 defined thereon, and a main unit 20 including a front face 22 secured to a housing 24. The housing has a socket 26 disposed on an interior 28 thereof adjacent an aperture 30 disposed opposite the front face 22. The socket 26 rotatably receives the ball joint portion 18 such that the main unit 20 is articulable on the mount 12 by rotation about three perpendicular axes (X, Y, and Z). First and second magnets 32a and 32b are positioned within the housing 24 and are mutually spaced apart to define a rotationally asymmetric combined magnetic field M (FIGS. 6-8) within the housing 24. First and second sensors 34a and 34b are positioned within the housing 24 and are mutually spaced apart so as to be collectively operably associated with the combined magnetic field M with articulation of the main unit 20 on the mount 12 causing movement of the first and second sensors 34a, 34b with respect to the first and second magnets 32a, 32b. A processor 35 is in communication with the first and second sensors 34a, 34b to receive magnetic field information related to the combined magnetic field M from the first sensor and second sensor 34a, 34b and to determine a rotational position of the main unit 20 in relation to the mount 12 about each of the three perpendicular axes (X, Y, Z) based on a combination of the magnetic field information from the first sensor and the second sensor 34a and 34b.

As can be appreciated, the rearview assembly 10 described herein can be used in connection with a vehicle, particularly within the interior thereof. In particular, rearview assembly 10 can be mounted adjacent a windshield of vehicle either by attachment of the mount 12 with the windshield itself or to an additional component adjacent or mounted to the headliner in an area above a top edge of the windshield (such mounting may be made to a portion of the vehicle frame, a vehicle panel, or other support structure, for example, through one or more apertures in the headliner). The above-mentioned connection of the main unit 20 with the mount 12 by way of the receipt of the ball joint portion 18 within the socket 26 associated with the main unit 20 facilitates positioning of the face 22 of the main unit 20 in a desired position within the vehicle interior. In particular, this positioning is made adjustable by the ball-and-socket joint 36 defined by the attachment of the ball joint portion 18 with the socket 26. As can be appreciated, this adjustable positioning is realized by articulation of the socket 26 about the ball joint portion 18 and is limited in a range of motion about the Z-axis and a similar range of motion about the X-axis by the size of the aperture 30 relative to a stem 38 that connects the ball joint portion 18 to a base 40 of the mount 12. In various implementations, the respective ranges of rotational motion about each of the Z-axis and X-axis can be at least about 30° from the centered position shown in FIGS. 1 and 6, although other variations are possible. In this respect, FIG. 2 shows the main unit 20 rotated about each of the Z-axis and the X-axis by 15° from the center position of FIG. 1.

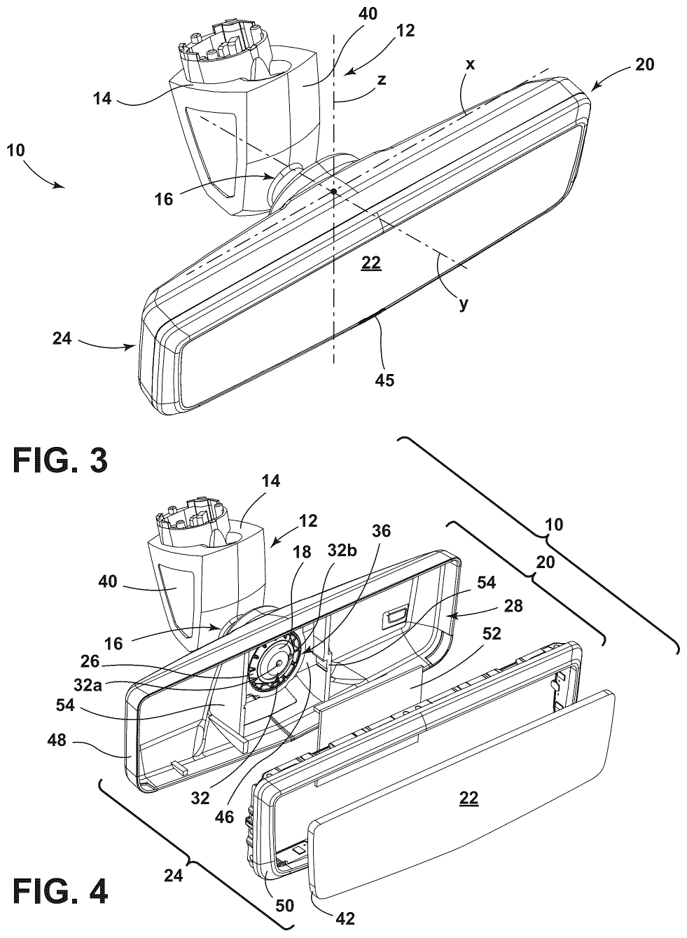

The structure of the joint 36 depicted herein can be such that the main unit 20 rotates freely on the ball joint 18 with respect to the Y-axis, although, in some aspects interference with the base 40 and/or adjacent parts of the vehicle (including, for example, the headliner) can restrict such rotation. In other aspects, additional structures within or associated with the joint 36 can restrict the Y-axis rotation of the main unit 20 to less than 360° about the ball joint portion 18 (for example, to within about 45° in either direction from the centered position of FIGS. 1 and 6) to prevent stressing or crimping of electrical connections between features within the interior 28 to the vehicle that pass through the joint 36 and the mount base 40. In this respect, FIG. 3 shows the main unit 20 rotated by about 10° on the Y-axis from the position of FIG. 2, discussed above.

In one example of the rearview assembly 10, described herein, the face 22 of the main unit 20 can be on a mirrored element 42 (FIG. 4) that is generally configured to present a reflected image of the view to the rear of vehicle to a driver and, accordingly, may be adjustable by movement of main unit 20 with respect to mount 12. In one embodiment, the mirrored element 42 can be in the form of an electro-optic element such that the face 22 is associated with a transparent element that encloses an electro-optic medium that can be made more transmissible or less transmissible by application of an electric current thereto. In such an example, an interior surface 44 of the mirrored element 42 defines the reflective surface. In such an example, the main unit 20 may include an interior imager 45 exposed on the housing 24 adjacent the mirrored element 42, with such imager, in one example, being useable in connection with a driver monitoring system.

In another example, the face 22 of the main unit 20 may be defined on a display unit (that is schematically similar to the mirrored element 42 shown in the drawings for purposes of this discussion). In this respect, the rearview assembly 10 may be what may be referred to as a full-display mirror. As can be appreciated, the display unit may be capable of displaying a simulated mirror-image of the view to the rear of the associated vehicle (that may be captured by an appropriately-positioned video camera or the like) when the display is in an active state.

Such an image may generally replicate that which would be available from a typical reflective mirror and can be supplemented with other information presented on the display unit. In one aspect, such an image may be responsive to the position of the main unit 20 about the mount 12, such that movement of the main unit 20 is linked with panning or rotation of the image presented on the display in the same way that movement of a mirrored surface changes the point-of-view of the reflected image. An example of such a system is discussed further in commonly assigned U.S. Pat. No. 10,525,890 (“the '890 Patent”), the entire contents of which are incorporated by reference herein.

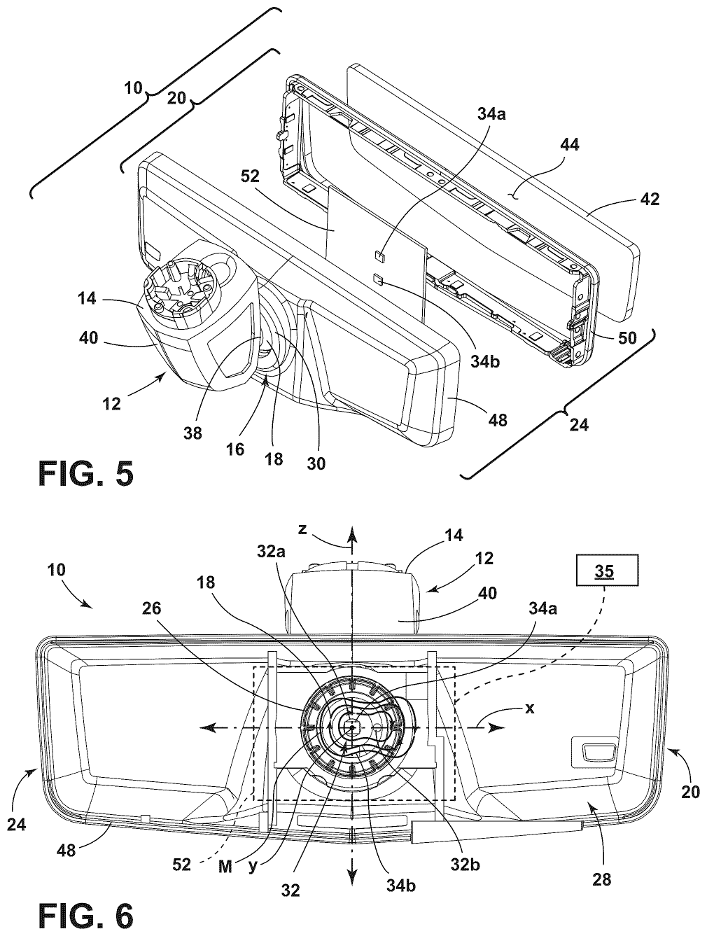

As can be seen in FIGS. 4 and 5, the socket 26 can be coupled with the housing 24 by way of a mounting plate 46 that can be assembled within or integrally molded as a part of the housing 24. In the illustrated example, the housing 24 includes a front (i.e., with respect to the orientation of the rearview mirror assembly 10 within a vehicle) housing portion 48, which is shown in the form of a single-piece unit and can be made from a single piece of injection molded plastic or the like, although other materials are possible. In the depicted embodiment, the mounting plate 46 can be coupled with the rear housing 48 on an interior 28 thereof such that the socket 26 aligns with the aperture 30, which is also formed in the rear housing 48. In turn, the depicted mirrored element 42 (or, in the alternative the display unit) can be coupled to the rear housing 48 by way of a bezel 50 or other secondary housing piece that affixes to the rear housing 48 to complete and enclose the housing 24, thereby defining the interior 28 along with the mirrored element 42. In this and other examples, the housing 24 is structured so that the interior 28 is of a sufficient depth to retain internal structures of rearview assembly 10, including the joint 36 and other related structures, such as those related to the above-described electro-optic element or display substrate, the interior imager 45 and other elements known in the art or described later herein.

As can be appreciated, the variations of the rearview assembly 10, discussed above, in which the rearview assembly 10 incorporates at least one of a position-responsive display associated with the face 22 and/or an interior imager 45 for driver monitoring, the associated systems may advantageously utilize position information of the main unit 20 relative to the mount 12. As further shown in FIGS. 4 and 5, such information may be obtained using the above-mentioned sensors 34a and 34b. In particular, the sensors 34a and 34b can be configured as magnetic field sensors that can determine the location of the above-described combined magnetic field M defined by the magnetic units 32a and 32b with respect to the sensors 34a and 34b, independently and once appropriately calibrated. In this manner, the sensors 34a and 34b can be mounted on a printed circuit board (“PCB”) 52 that is mounted within the interior 28 of housing 24. In one aspect, the PCB 52 can be mounted by mechanical fasteners or the like to spaced-apart ribs 54 formed with the front housing 48 with which the mounting plate 46 is connected or formed.

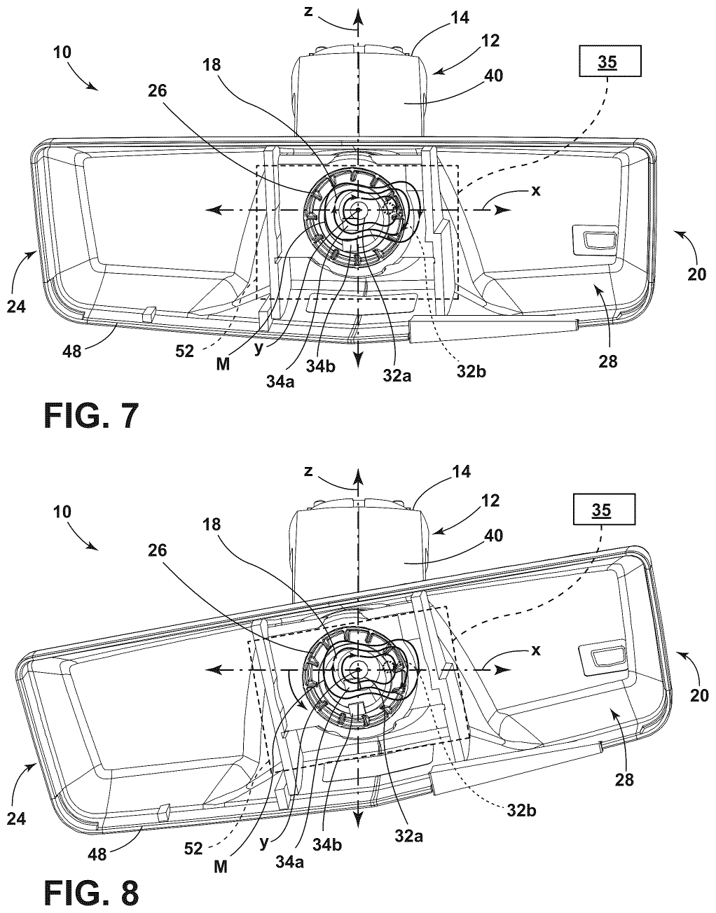

As further shown, the magnetic units 32a and 32b can comprise fixed magnets received within respective bosses formed in the ball joint portion 18. In this arrangement, the fixed magnets 32a and 32b remain stationary while the sensors 34a and 34b move with the main unit 20 during articulation thereof about the ball joint portion 18. In one aspect, the rotation of the main unit 20 about the Z-axis and the X-axis can be generally determined by the processor 35 by correlating the location of sensor 34a with respect to the magnetic field M in the X-Z plane, as shown in FIG. 6, wherein alignment of sensor 34a with the magnet 32a in the X-Z plane indicates the depicted centered position, and in FIG. 7, wherein the displaced position in the Z-direction and the X-direction correlates with the position shown in FIG. 2, wherein the main unit 20 is rotated on both the X-axis and the Z-axis, as described above. In one aspect, the above-mentioned magnetic field information can include the general location of the combined magnetic field M relative to the first sensor 34a. With the location of the first and second magnets 32a and 32b relative to the first sensor 34a, as well as with respect to the ball joint portion 18 known, the processor 35 can use the combined magnetic field M location along the X- and Z-axes, as determined by the first sensor 34a to determine the rotation of the main unit 20 about the Z- and X-axes, respectively. In one example, a “joystick” position sensor available through Melexis of Belgium, EU, can be used for sensor 34a.

Notably, the additional rotation of the main unit 20 about the Y-axis between, for example, FIGS. 2 and 3 does not change the relative location of the combined magnetic field M with respect to magnet 32a in the X-Z plane. Accordingly, additional information is needed for this determination. In the present arrangement, magnetic field information associated with the combined magnetic field M from the second sensor 34b can be used to measure rotation of the main unit 20 about the Y-axis. As discussed above, in the illustrated example, the first magnet 32a and the first sensor 34a are aligned along the Y-axis (when main unit 20 is in the centered position), which generally facilitates the determination of the X-axis and Z-axis rotation, as discussed above. By contrast, for Y-axis rotational measurement in the illustrated example, the second magnet 32b and the second sensor 34b are preferably displaced from the first magnet 32a and the first sensor 34a, respectively, in different directions. In present example, the second magnet 32b is coupled with the ball portion 18 of the mount 12 in a location that is spaced from the location of the first magnet 32a in the direction of the X-axis (with it being understood that the magnet 32b may not lie along the X-axis or be displaced only along the X-axis, as the geometry of the ball joint portion 18 may result in the second magnet 32b being also displaced at least in the Y-axis direction), and the second sensor 34b is mounted on the printed circuit board 52 in a position spaced from the first sensor 34a in a direction along the Z-axis (i.e., vertically downward in the illustrated arrangement). In various examples, the magnets 32a, 32b can be spaced apart by between 5 mm and 15 mm in the X-axis direction, with the sensors 34a, 34b being spaced apart by between 5 mm and 15 mm in the Z-axis direction, with other spacings being possible depending on the location of the various components and the resulting availability of space to accommodate a greater distance, as well as the sensitivity of the sensors 34a, 34b and/or the strength of the magnets 32a, 32b.

In the depicted configuration, the second sensor 34b can use magnetic field information related to the proximity of the combined magnetic field M relative to the second sensor 34b to determine rotation of the main unit 20 about the Y-axis with no ambiguity in a rotation of +/−90 degrees. As shown, the positioning of the second magnet 32b elongates the combined magnetic field M in the X-axis direction resulting in the radially asymmetric character of the combined magnetic field M, discussed above. Accordingly, the rotation of the main unit 20 and corresponding rotational movement of the second sensor 34b moves the second sensor 34b closer to or farther away (depending on the direction of rotation) from at least the portion of the combined magnetic field M influenced by the second magnet 32b, which results in a detectable change in position of the combined magnetic field M with respect to the second sensor 34b. In this respect, it can be appreciated that the second sensor 34b need not be a three-axis sensor. In one example, a single axis sensor (e.g., Z-axis), or a sensor that simply measures the magnitude of the magnetic field, may be sufficient for Y-axis rotation measurement.

In one example, at +90 degrees second sensor 34b may measure a maximum field magnitude, while at −90 degrees second sensor 34b measures minimum magnetic field magnitude. It is also to be appreciated that relative positioning of the sensors 34a and 34b relative to each other and relative to the respective magnets 32a and 32b is configured to maintain the sensors 34a and 34b in operable association with the first and second magnets 32a and 32b, collectively, and effectively, with the resulting combined magnetic field M. In general, the operable association is such that the magnets 32a and 32b and the resulting combined magnetic field M are in a reliable operating range of the sensors 34a and 34b through the range of movement of the main unit 20 relative to the mount 12. Additionally, the operable association is such that the sensors 34a and 34b are positioned relative to the magnets 32a and 32b such that they can, collectively, provide information useable to determine the rotational position of the main unit 20 relative to the mount 12 according to the principles discussed in the various examples herein, and given the specific geometry of the rearview assembly 10.

It is noted that the magnetic field within the housing 24 and to which the first and second sensors 34a and 34b are exposed will be influenced by additional magnetic or electromagnetic elements or features within and outside of the associated vehicle. In this respect, the use of two sensors 34a and 34b, discussed herein, can further allow for magnetic background field subtraction or magnetic far-field, common-mode rejection even if the sensors are very sensitive to magnetic field (e.g., sensitivity in the order of milligauss). In a variation in which both sensors 34a and 34b are configured for magnetic field measurement (and, accordingly, positioning) in the X, Y, and Z directions, common-mode magnetic fields can be subtracted off each other, if the magnets 32a and 32b are close enough to each other such that sensors 34a and 34b can sense the same far-field magnetic fields. Far-field magnetic fields may come from the Earth's magnetic field or intrinsic fields produced by a vehicle and its parts.

While further arrangements of the magnets 32a and 32b, as well as the sensors 34a and 34b are possible for measurement of the rotational position or the main unit 20 the relative orientation and positioning of the sensors 34a and 34b and the magnets 32a and 32b can be developed according to various considerations to achieve acceptable measurement results. For example, the depicted placement of the sensors 34a and 34b along a line that lies perpendicular to a corresponding line defined between the magnets 32a and 32b, for example, avoids the exposure of the sensors 34a and 34b to similar magnetic component values when the main unit 20 is at Y-axis rotational positions of +90° and −90°. The mutual arrangement of the magnets 32a, 32b and sensors 34a, 34b such that at least the practically-reachable Y-axis rotational positions of the main unit 20 relative to the mount 12 expose at least sensor 34b to distinct magnetic components make the orientation measurement utilizing such measurements unambiguous. In a similar manner, the configuration and arrangement of the magnets 32a and 32b with respect to polarity can also influence the position measurement reading using the sensors 34a and 34b. In the present example, both magnets 32a and 32b are mounted in the ball joint portion 18 with their poles pointing in the same direction, which can help avoid a condition in which the magnetic field paths exhibit a small change in direction due to the mutual influence of opposing polarity on the respective fields, which can lead to inaccuracies in measurement or necessary additional calibration.

As discussed above, the sensors 34a and 34b are configured to interpret the sensed magnetic field information as at least one type of position information of the associated magnet 32a or 32b with respect to the sensor 34a or 34b. As discussed, this position information can be single-axis or general proximity positioning or multi-axis (e.g., two or three axis) proximity, depending on the particular arrangement of magnets 32a, 32b and sensors 34a, 34b and the utilized detection scheme. In this respect, the processor 35 is generally configured to receive the sensor information in the form of a general position of the magnets 32a, 32b relative to the sensors 34a and 34b and, according to the mutual arrangement thereof, the detection scheme and the geometry of the main unit 20 and mount 12, including the movement of main unit 20 on mount 12, to use that information to calculate the position of the main unit 20 relative to the mount 12 and, accordingly within the vehicle, if desired. In the variation discussed above and those discussed generally below, two sensors 34a and 34b are used to measure, within a certain range, rotation about the X-, Y-, and Z-axes distinctly and/or uniquely. However, it is noted that additional sensors 34 may improve the resolution and range of the angles that can be measured, including without additional magnets, although arrangements with additional sensors and magnets are contemplated. It is also noted that, in principle, a single magnet can be fabricated to create the magnetic fields produced by two magnets, but some useable field patterns are simpler to achieve with two or more separate magnets. In this respect herein, a single magnet producing two separate magnetic fields is considered as including two separate magnetic units for purposes of this disclosure.

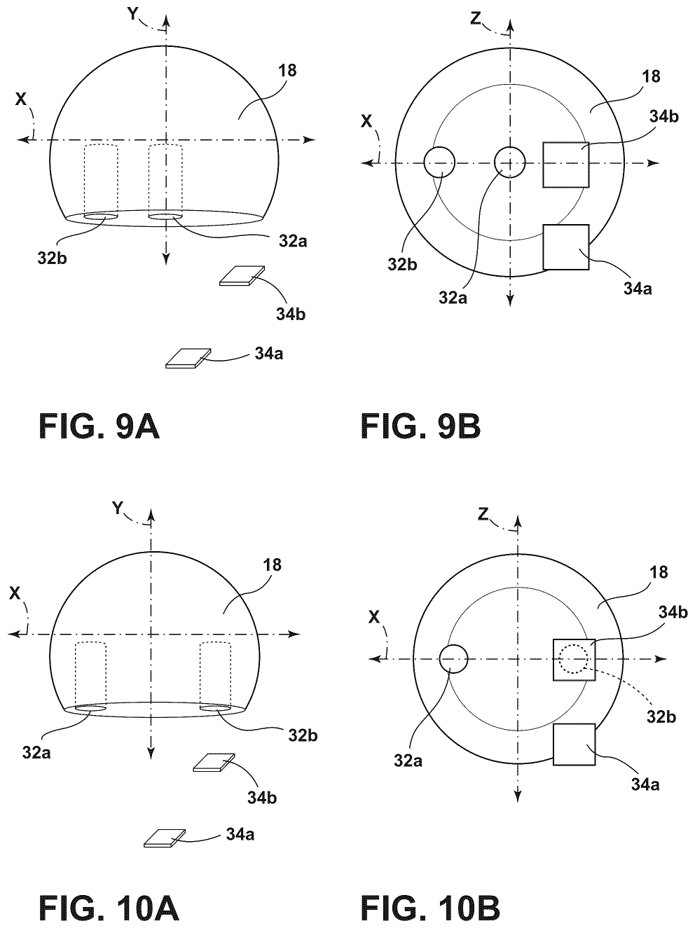

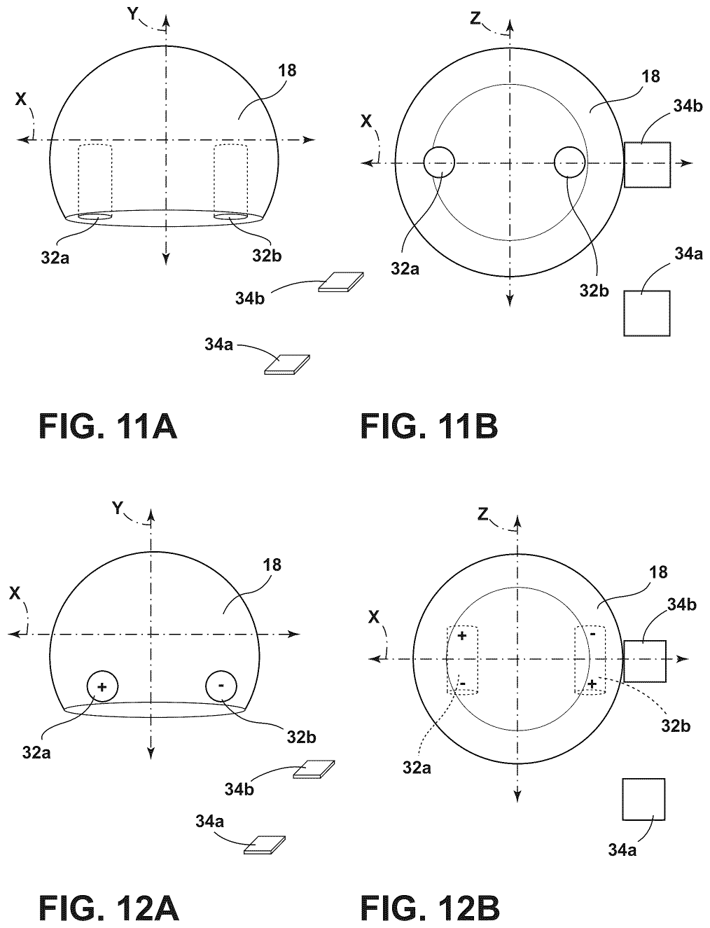

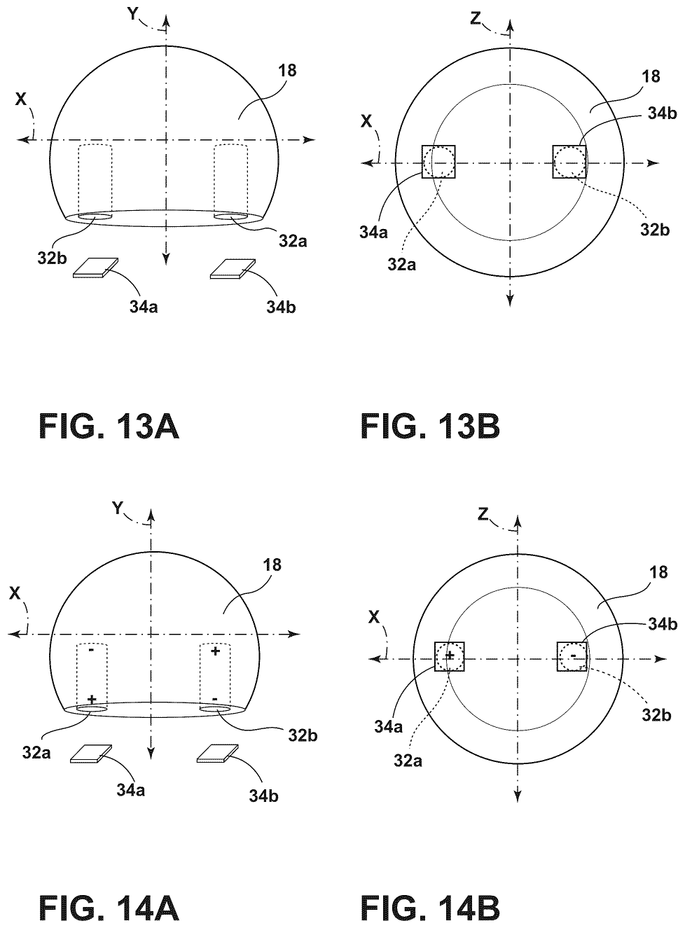

FIGS. 9A through 14B show various additional arrangements of magnets 32a, 32b and sensors 34a, 34b that can be used in the above-described scheme to determine the rotational position of the main unit 20 with respect to the mount 12 with respect to the X-, Y-, and Z-axes. Each variation is depicted schematically, showing the locations of the magnets 32a, 32b with respect to the ball joint portion 18 and the sensors 34a, 34b with respect to the magnets 32a, 32b. In general FIGS. 9A, 10A, 11A, 12A, 13A, and 14A show top plan views (i.e., along the X-Y plane) and FIGS. 9B, 10B, 11B, 12B, 13B, and 14B show front elevation views (i.e., along the X-Z plane). More specifically, in FIGS. 9A and 9B, an arrangement is shown in which both sensors 34a, 34b are displaced from the corresponding magnets 32a, 32b when the main unit 20 is in the centered position such that the sensor 34a reading does not present mirror values in rotation about the X- or Z-axes, similar to the reading from sensor 34b in the example illustrated in FIGS. 3-8. FIGS. 10A and 10B, as well as FIGS. 11A and 11B show variations in which the magnets 32a and 32b are positioned on opposite lateral sides of the ball joint 18, with the respective sensors 34a and 34b displaced therefrom in variations similar to those discussed above. FIGS. 12A and 12B show a variation in which the magnets 32a and 32b are spaced in the Z-axis direction such that the corresponding sensors 34a and 34b are positioned to move between the poles of the magnets 32a and 32b to provide such additional information for use in the position determination. In the illustrated example, the magnets 32a and 32b are positioned in opposite orientations, although other variations are possible. FIGS. 13A and 13B show a variation in which the sensors 34a, 34b are aligned with respective ones of the magnets 32a and 32b. In this variation, both sensors 34a and 34b are configured as at least two-direction sensors (X- and Z-axes, for example) and can be used together to determine the Y-axis rotation of the main unit 20. FIGS. 14A and 14B show a similar variation, in which the polarities of the magnets 32a and 32b are reversed relative to each other.

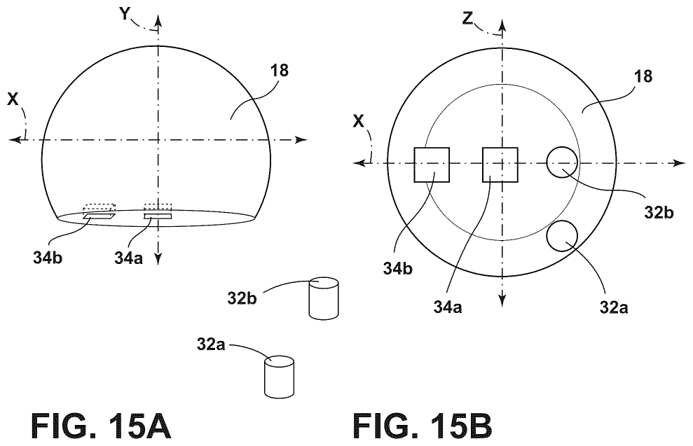

It is noted that in all of the illustrated examples referred to above, the magnets 32a and 32b are embedded into the ball joint portion 18, while the sensors 34a and 34b are mounted on the PCB 52 that is coupled with the ribs 54 within the housing 48 of the main unit 20. In this respect, it is to be appreciated that the scheme for determining the rotational positioning of the main unit 20 about the mount can be made in a variation, shown in FIGS. 15A and 15B, in which the magnets 32a, 32b are fixed with the housing 48 and the sensors 34a, 34b are embedded in or otherwise coupled with the ball joint portion 18. In this respect, it is noted that modifications can be made to the positioning of the PCB 52 and the connection of the sensors 34a and 34b therewith. In such an arrangement, the positioning of the main unit 20 relative to the mount can be made according to similar principles to those discussed above.

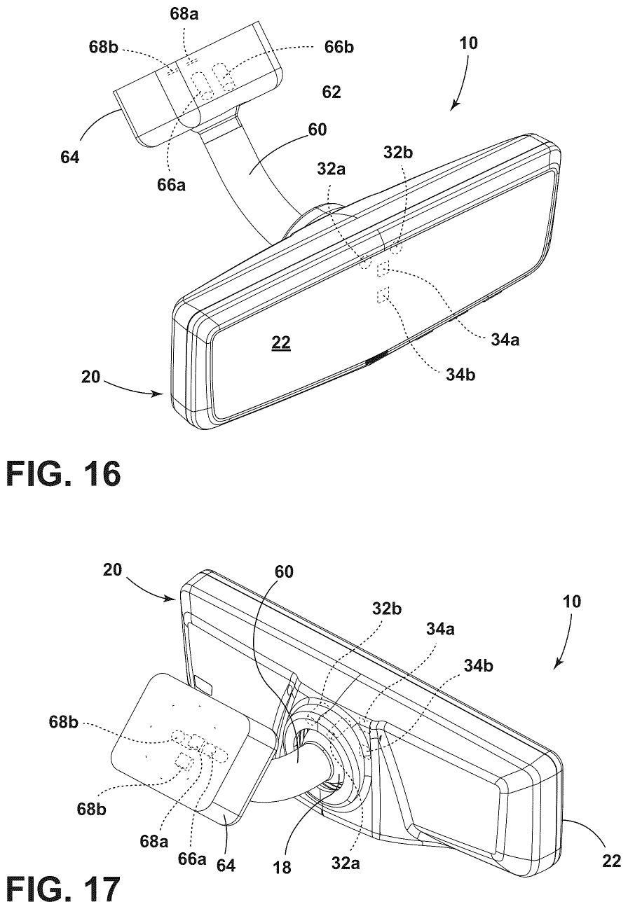

Still further, as shown in FIGS. 16 and 17, the system disclosed herein can be adapted to operate in variations of a rearview assembly 10 in which the mount 12 includes an arm 60 with a second ball joint 62 that connects the arm 60 to a base 64. In such a system, the position of the main unit 20, including the face 22 depends not only on the position of the main unit with respect to the ball joint portion 18 with which it is immediately connected, but also the position of the second ball joint 62 with respect to the base 64. Accordingly, a variation of the present rearview assembly 10 for determining the position of the main unit 20 with respect to the base 64 can include an additional set of magnets 66a and 66b embedded in the second ball joint portion 62 and corresponding sensors 68a and 68b mounted within the base 64 or within the adjacent headliner of the vehicle (e.g., on an additional printed circuit board or the like). In this manner, an additional determination can be made regarding the positioning of the arm 60 about the base 64 that can be used with the determination of the position of the main unit 20 about the arm 60 to determine the position of the main unit 20. It is to be appreciated that variations of the magnet 32a, 32b and sensors 34a, 34b discussed above can also be adapted for use in such an assembly 10. In a further aspect, the second ball joint 62 can be configured to limit or prevent rotation of the arm 60 with respect to the base 64 such that the position of the arm 60 can be measured using a single magnet-sensor combination in along two axes.

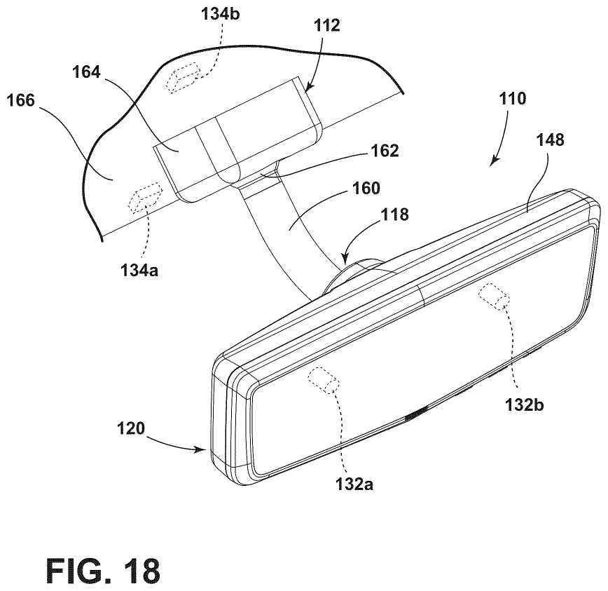

In a further variation, shown in FIG. 18, the magnets 132a and 132b are fixed with the housing 148 and the sensors 134a, 134b are positioned in a fixed location relative to the vehicle. In various examples, the sensors 134a, 134b can be embedded within the mount 112 outside the ball joint portion 118, or positioned within the headliner 166 or associated components or features practically proximate the main unit 120. In further variations, one magnet and one sensor can be coupled with the ball joint portion 118 and another magnet and sensor can be coupled with the housing 148 in similar mutual arrangements as discussed herein. In still further variations, the magnets 132a and 132b can be positioned in locations outside of the housing 148. In one example, the magnets 132a and 132b can be coupled with or otherwise positioned within the mount 112 outside of the ball joint portion 118, within the headliner 166 of the vehicle, or other locations proximate enough to the magnets 132a, 132b, given the magnet strength and the sensitivity and/or resolution range of the sensors 134a and 134b. For example, magneto-resistance based sensors (e.g., as currently used in vehicle compasses and having, for example sensitivity in the range of +/−8 Gauss and +/−16 Gauss) are about 2 orders of magnitude or more sensitive than hall-effect magnetic sensors, which may otherwise be suitable for the example described in connection with other variations of the disclosed system. Such sensors can be used in the described variations in which the magnets 132a, 132b or sensors 134a, 134b are positioned outside of the mount 112, such as in the headliner or the like, particularly when used in connection with multiple sensors to implement various forms of noise cancelling and/or common mode rejection.

The invention disclosed herein is further summarized in the following paragraphs and is further characterized by combinations of any and all of the various aspects described therein.

According to an aspect, a rearview assembly includes a mount having an arm with a first end and a second end, wherein the first end includes a first ball joint portion and a main unit including a front face secured to a housing. The housing has a first socket disposed on an interior thereof adjacent an aperture disposed opposite the front face. The socket rotatably receives the first ball joint portion such that the first ball joint portion of the mount is at least partially disposed within the housing and such that the main unit is articulable on the mount by rotation about three perpendicular axes. The assembly further includes first and second magnets positioned within one of the housing or the first ball joint portion and mutually spaced apart to define a rotationally asymmetric combined magnetic field within the housing and first and second sensors at least partially positioned within the other of the housing or the first ball joint portion and being mutually spaced apart so as to be collectively operably associated with the combined magnetic field. Articulation of the main unit on the mount causing movement of the first and second sensors with respect to the first and second magnets. A processor is in communication with the first and second sensors to receive magnetic field information related to the combined magnetic field from the first sensor and second sensor and to determine a rotational position of the main unit in relation to the mount about each of the three perpendicular axes based on a combination of the magnetic field information from the first sensor and the second sensor.

In the rearview assembly of ¶ [0052], the first and second magnets can be spaced apart in the direction of a first one of the three perpendicular axes, and the first and second sensors can be spaced apart in the direction of a second one of the three perpendicular axes.

In the rearview assembly of ¶ [0053], the processor can determine the rotational position of the main unit with respect to the mount about the first and second ones of the three perpendicular axes using the magnetic field information from the first sensor, and the processor can determine the rotational position of the main unit with respect to the mount about a third one of the three perpendicular axes using the magnetic field information from the second sensor.

In the rearview assembly of any one of ¶¶ [0052] to [0054], the first and second magnets can be positioned within and coupled with the first ball joint portion, and the first and second sensors can be positioned within and coupled with the main unit.

In the rearview assembly of any one of ¶¶ [0052] to [0055], the first and second magnets can comprise permanent magnets.

In the rearview assembly of any one of ¶¶ [0052] to [0056], the front face can be defined on a mirror coupled with the housing.

In the rearview assembly of ¶¶ [0052] to [0057], the front face can be defined on a display coupled with the housing.

A rearview assembly includes a mount having an arm with a first end and a second end, wherein the first end includes a first ball joint portion and a main unit including a front face secured to a housing. The housing has a first socket disposed on an interior thereof adjacent an aperture disposed opposite the front face, and the socket rotatably receives the first ball joint portion such that the first ball joint portion of the mount is at least partially disposed within the housing and such that the main unit is articulable on the mount by rotation about three perpendicular axes. The assembly further includes first and second magnets positioned within the first ball joint portion and mutually spaced apart to define a first rotationally asymmetric combined magnetic field within the housing and first and second sensors positioned within the housing and being mutually spaced apart so as to be collectively operably associated with the first combined magnetic field. Articulation of the main unit on the mount cause movement of the first and second sensors with respect to the first and second magnets. A processor is in communication with the first and second sensors to receive magnetic field information related to the first combined magnetic field from the first sensor and second sensor and to determine a rotational position of the main unit in relation to the mount about each of the three perpendicular axes based on a combination of the magnetic field information from the first sensor and the second sensor.

In the rearview assembly of ¶ [0059], the first and second magnets can be spaced apart in the direction of a first one of the three perpendicular axes, and the first and second sensors can be spaced apart in the direction of a second one of the three perpendicular axes.

In the rearview assembly of ¶ [0060], the processor can determine the rotational position of the main unit with respect to the mount about the first and second ones of the three perpendicular axes using the magnetic field information from the first sensor, and the processor can determine the rotational position of the main unit with respect to the mount about a third one of the three perpendicular axes using the magnetic field information from the second sensor.

In the rearview assembly of ¶ [0059], the first and second magnets can be at least partially embedded within the first ball joint portion, and the first and second sensors can be coupled with the main unit.

In the rearview assembly of any one of ¶¶ [0059] to [0062], the first and second magnets can comprise permanent magnets.

In the rearview assembly of ¶ [0059], wherein the mount can include a base having a second socket receiving a second ball joint portion defined on the second end of the arm, and the assembly can further include third and fourth magnets positioned within the second ball joint portion and mutually spaced apart to define a second rotationally asymmetric combined magnetic field within the base of the mount and third and fourth sensors positioned within the base of the mount and being mutually spaced apart so as to be collectively operably associated with the second combined magnetic field, articulation of the arm about the base causing movement of the third and fourth sensors with respect to the third and fourth magnets.

In the rearview assembly of ¶ [0064], the processor can be in communication with the third and fourth sensors to receive magnetic field information related to the second combined magnetic field from the third sensor and fourth sensor and to determine the rotational position of the main unit in relation to the mount about each of the three perpendicular axes based on a combination of the magnetic field information from the third sensor and the fourth sensor in addition to the combination of the magnetic field information from the first senor and the second sensor.

According to another aspect, a rearview positioning system includes a mount having an arm with a first end and a second end, the first end including a first ball joint portion, and the mount being coupleable within a vehicle interior. The system further includes a main unit including a front face secured to a housing. The housing has a first socket disposed on an interior thereof adjacent an aperture disposed opposite the front face. The socket rotatably receives the first ball joint portion such that the first ball joint portion of the mount is at least partially disposed within the housing and such that the main unit is articulable on the mount by rotation about three perpendicular axes. First and second magnets are mutually spaced apart to define a rotationally asymmetric combined magnetic field, and first and second sensors are mutually spaced apart so as to be collectively operably associated with the combined magnetic field. Articulation of the main unit on the mount causes movement of the first and second sensors with respect to the first and second magnets. A processor is in communication with the first and second sensors, one of the first and second sensors or the first and second magnets are mounted in a fixed position relative to the vehicle interior, and the other of the first and second sensors or the first and second magnets are mounted within the main unit. The processor is configured to receive magnetic field information related to the combined magnetic field from the first sensor and second sensor and to determine a position of the main unit in relation to the mount about each of the three perpendicular axes based on a combination of the magnetic field information from the first sensor and the second sensor.

In the rearview positioning system of ¶ [0066], the first and second magnets can comprise permanent magnets.

In the rearview positioning system of ¶ [0066] or ¶ [0067], the first and second magnets can be mounted within the housing of the main unit.

In the rearview positioning system of ¶ [0068], the first and second sensors can be mounted within a base of the mount adjacent the second end of the arm or within a headliner of the vehicle proximate the mount.

In the rearview positioning system of ¶ [0066] or ¶ [0067], the first and second magnets can be spaced apart in the direction of a first one of the three perpendicular axes, and the first and second sensors can be spaced apart in the direction of a second one of the three perpendicular axes.

In the rearview positioning system of ¶ [0066] or ¶ [0067], the first and second magnets can be positioned within and coupled with the first ball joint portion, and the first and second sensors can be positioned within and coupled with the main unit.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A rearview assembly comprising:
a mount having an arm with a first end and a second end, wherein the first end includes a first ball joint portion;
a main unit including a front face secured to a housing, the housing having a first socket disposed on an interior thereof adjacent an aperture disposed opposite the front face, the socket rotatably receiving the first ball joint portion such that the first ball joint portion of the mount is at least partially disposed within the housing and such that the main unit is articulable on the mount by rotation about three perpendicular axes;
first and second magnets positioned within one of the housing or the first ball joint portion and mutually spaced apart to define a rotationally asymmetric combined magnetic field within the housing;
first and second sensors at least partially positioned within the other of the housing or the first ball joint portion and being mutually spaced apart so as to be collectively operably associated with the combined magnetic field, articulation of the main unit on the mount causing movement of the first and second sensors with respect to the first and second magnets;
a processor in communication with the first and second sensors to receive magnetic field information related to the combined magnetic field from the first sensor and second sensor and to determine a rotational position of the main unit in relation to the mount about each of the three perpendicular axes based on a combination of the magnetic field information from the first sensor and the second sensor.

2. The rearview assembly of claim 1, wherein:
the first and second magnets are spaced apart in a first direction of a first one of the three perpendicular axes; and
the first and second sensors are spaced apart in the direction of a second one of the three perpendicular axes.

3. The rearview assembly of claim 2, wherein:
the processor determines the rotational position of the main unit with respect to the mount about the first and second ones of the three perpendicular axes using the magnetic field information from the first sensor; and
the processor determines the rotational position of the main unit with respect to the mount about a third one of the three perpendicular axes using the magnetic field information from the second sensor.

4. The rearview assembly of claim 1, wherein:
the first and second magnets are positioned within and coupled with the first ball joint portion; and
the first and second sensors are positioned within and coupled with the main unit.

5. The rearview assembly of claim 1, wherein the first and second magnets comprise permanent magnets.

6. The rearview assembly of claim 1, wherein the front face is defined on a mirror coupled with the housing.

7. The rearview assembly of claim 1, wherein the front face is defined on a display coupled with the housing.

8. A rearview assembly comprising:
a mount having an arm with a first end and a second end, wherein the first end includes a first ball joint portion;
a main unit including a front face secured to a housing, the housing having a first socket disposed on an interior thereof adjacent an aperture disposed opposite the front face, the first socket rotatably receiving the first ball joint portion such that the first ball joint portion of the mount is at least partially disposed within the housing and such that the main unit is articulable on the mount by rotation about three perpendicular axes;
first and second magnets positioned within the first ball joint portion and mutually spaced apart to define a first rotationally asymmetric combined magnetic field within the housing;
first and second sensors positioned within the housing and being mutually spaced apart so as to be collectively operably associated with the first combined magnetic field, articulation of the main unit on the mount causing movement of the first and second sensors with respect to the first and second magnets;
a processor in communication with the first and second sensors to receive magnetic field information related to the first combined magnetic field from the first sensor and second sensor and to determine a rotational position of the main unit in relation to the mount about each of the three perpendicular axes based on a combination of the magnetic field information from the first sensor and the second sensor.

9. The rearview assembly of claim 8, wherein:
the first and second magnets are spaced apart in a first direction of a first one of the three perpendicular axes; and
the first and second sensors are spaced apart in the direction of a second one of the three perpendicular axes.

10. The rearview assembly of claim 9, wherein:
the processor determines the rotational position of the main unit with respect to the mount about the first and second ones of the three perpendicular axes using the magnetic field information from the first sensor; and
the processor determines the rotational position of the main unit with respect to the mount about a third one of the three perpendicular axes using the magnetic field information from the second sensor.

11. The rearview assembly of claim 8, wherein:
the first and second magnets are at least partially embedded within the first ball joint portion; and
the first and second sensors are coupled with the main unit.

12. The rearview assembly of claim 8, wherein the first and second magnets comprise permanent magnets.

13. The rearview assembly of claim 8, wherein the mount includes a base having a second socket receiving a second ball joint portion defined on the second end of the arm, the assembly further including:
third and fourth magnets positioned within the second ball joint portion and mutually spaced apart to define a second rotationally asymmetric combined magnetic field within the base of the mount; and
third and fourth sensors positioned within the base of the mount and being mutually spaced apart so as to be collectively operably associated with the second combined magnetic field, articulation of the arm about the base causing movement of the third and fourth sensors with respect to the third and fourth magnets.

14. The rearview assembly of claim 13, wherein the processor is in communication with the third and fourth sensors to receive magnetic field information related to the second combined magnetic field from the third sensor and fourth sensor and to determine the rotational position of the main unit in relation to the mount about each of the three perpendicular axes based on a combination of the magnetic field information from the third sensor and the fourth sensor in addition to the combination of the magnetic field information from the first sensor and the second sensor.

15. A rearview positioning system comprising:
a mount having an arm with a first end and a second end, wherein the first end includes a first ball joint portion, the mount being coupleable within a vehicle interior;
a main unit including a front face secured to a housing, the housing having a first socket disposed on an interior thereof adjacent an aperture disposed opposite the front face, the socket rotatably receiving the first ball joint portion such that the first ball joint portion of the mount is at least partially disposed within the housing and such that the main unit is articulable on the mount by rotation about three perpendicular axes;
first and second magnets being mutually spaced apart to define a rotationally asymmetric combined magnetic field;
first and second sensors being mutually spaced apart so as to be collectively operably associated with the combined magnetic field, articulation of the main unit on the mount causing movement of the first and second sensors with respect to the first and second magnets; and
a processor in communication with the first and second sensors;
wherein:
one of the first and second sensors or the first and second magnets are mounted in a fixed position relative to the vehicle interior;
the other of the first and second sensors or the first and second magnets are mounted within the main unit;
and the processor is configured to receive magnetic field information related to the combined magnetic field from the first sensor and second sensor and to determine a position of the main unit in relation to the mount about each of the three perpendicular axes based on a combination of the magnetic field information from the first sensor and the second sensor.

16. The rearview positioning system of claim 15, wherein the first and second magnets comprise permanent magnets.

17. The rearview positioning system of claim 15, wherein the first and second magnets are mounted within the housing of the main unit.

18. The rearview positioning system of claim 17, wherein the first and second sensors are mounted within a base of the mount adjacent the second end of the arm or within a headliner of the vehicle proximate the mount.

19. The rearview positioning system of claim 15, wherein:
the first and second magnets are spaced apart in a first direction of a first one of the three perpendicular axes; and
the first and second sensors are spaced apart in the direction of a second one of the three perpendicular axes.

20. The rearview positioning system of claim 15, wherein:
the first and second magnets are positioned within and coupled with the first ball joint portion; and
the first and second sensors are positioned within and coupled with the main unit.
